(19) United States
(12) Patent Application Publication
(10) Pub. No.: US 2025/0269798 A1
(43) Pub. Date: Aug. 28, 2025

(54) STORAGE TUB WITH ACCESS PANEL FOR A VEHICLE

(71) Applicant: Rivian IP Holdings, LLC, Irvine, CA (US)

(72) Inventor: Nialls Yves CHERAK, Costa Mesa, CA (US)

(21) Appl. No.: 18/797,402

(22) Filed: Aug. 7, 2024

Related U.S. Application Data
(60) Provisional application No. 63/558,920, filed on Feb. 28, 2024.

(51) Int. Cl. B60R 5/02; B62D 25/08; B62D 25/12

(52) U.S. Cl. CPC B60R 5/02; B62D 25/087; B62D 25/12

(57) ABSTRACT

A vehicle component includes a tub configured to store cargo and an access panel configured to cover at least a portion of the bay defined by the vehicle. A living hinge couples the tub to the access panel. All of the tub, the access panel, and the living hinge are monolithically formed in a common mold, such as using gate sequenced injection molding. The component may include side portions secured to the tube. The living hinge may include a first portion connecting a first side portion to the access panel and a second portion connecting a second side portion to the access panel. The tub may be detached from the access panel between the first and second side portions. An upper edge of the tube may have a dust seal secured thereto that engages a cover, e.g., hood, configured to cover the bay.

### CROSS-REFERENCE TO RELATED APPLICATIONS

This application claims priority to and benefit of U.S. Provisional Patent Application No. 63/558,920, filed Feb. 28, 2024, which is assigned to the assignee hereof and hereby expressly incorporated herein in its entirety as if fully set forth below and for all applicable purposes.

### INTRODUCTION

The present disclosure relates to a storage tub with an integrated access panel for a vehicle.

### SUMMARY

The present disclosure describes an approach for implementing an access panel in a bay of a vehicle. In one aspect, a vehicle component includes a tub configured to store cargo and an access panel configured to cover at least a portion of the bay defined by the vehicle. A living hinge couples the tub to the access panel. All of the tub, the access panel, and the living hinge are monolithically formed in a common mold.

### BRIEF DESCRIPTION OF THE DRAWINGS

FIG. 1A illustrates an example vehicle that may be used in accordance with certain embodiments.

FIG. 1B illustrates a chassis of a vehicle having multiple drive units that may be used in accordance with certain embodiments.

FIG. 2A is an isometric view of a front body portion of a vehicle defining a front bay in accordance with certain embodiments.

FIG. 2B is an isometric view of the front body portion of the vehicle having a tub and access panel mounted in a front bay of the vehicle in accordance with certain embodiments.

FIG. 2C is an isometric view of the front body portion of the vehicle having an apron panel mounted in the front bay of the vehicle in accordance with certain embodiments.

FIGS. 3A and 3B illustrate pivoting of the access panel relative to the tub in accordance with certain embodiments.

FIGS. 4A, 4B, and 4C illustrate the operation of a living hinge coupling the access panel to the tub in accordance with certain embodiments.

FIG. 5 is an isometric view showing latching of the access panel with respect to a leaf screen and a dust seal secured around the tub in accordance with certain embodiments.

FIG. 6 illustrates a gap formed between the tub and the access panel in accordance with certain embodiments.

FIG. 7 illustrates interaction between the access panel and the dust seal during pivoting in accordance with certain embodiments.

FIG. 8 is a side view illustrating a fastener for latching the access panel to the leaf screen in accordance with certain embodiments.

### DETAILED DESCRIPTION

A tub used to store cargo (e.g., a frunk) is positioned in a bay defined by a vehicle. The tub is secured to an access panel by a living hinge. The access panel may provide access to, for example, one or more reservoirs for fluids or other components. The tub and access panel are formed monolithically in a common mold. Mounting of the access panel to the tub does not require additional fasteners. Side portions mounted to the tub may be connected to the access panel by portions of the living hinge with the tub being disconnected from the access panel between the side portions. The access panel may releasably latch to a component in the bay, such as a leaf guard.

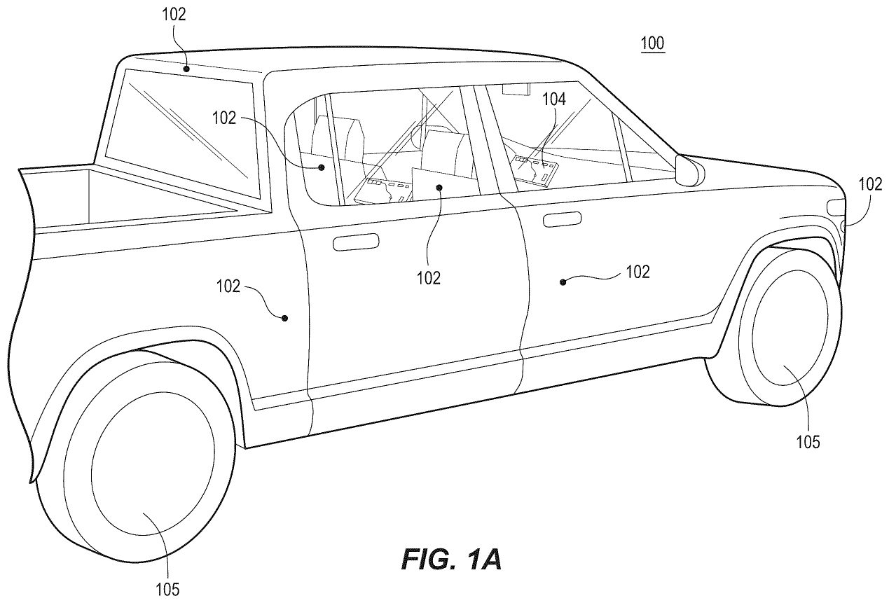

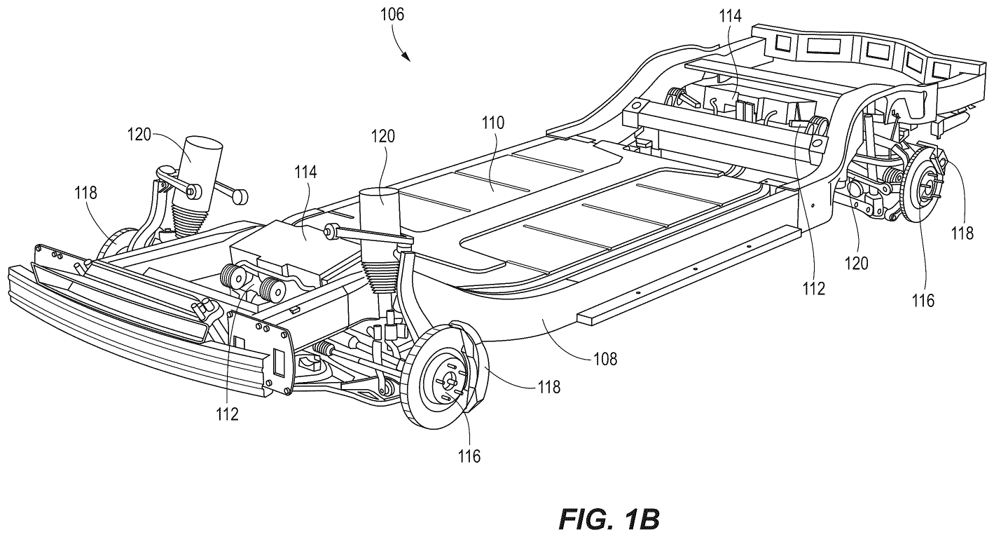

FIG. 1A illustrates an example vehicle 100 in which the approach described herein may be implemented. As seen in FIG. 1A, the vehicle 100 has multiple exterior cameras 102 and one or more front displays 104. Each of these exterior cameras 102 may capture a particular view or perspective on the outside of the vehicle 100. The images or videos captured by the exterior cameras 102 may then be presented on one or more displays in the vehicle 100, such as the one or more front displays 104, for viewing by a driver. The vehicle 100 further includes a plurality of road wheels 105, such as four, that are driven to propel the vehicle 100 over a surface.

Referring to FIG. 1B, the vehicle 100 may include a chassis 106 including a frame 108 providing a primary structural member of the vehicle 100. The frame 108 may be formed of one or more beams or other structural members or may be integrated with the body of the vehicle (e.g., unibody construction).

In embodiments where the vehicle 100 is a battery electric vehicle (BEV) or possibly a hybrid vehicle, a large battery 110 is mounted to the chassis 106 and may occupy a substantial portion (e.g., at least 80 percent) of an area within the frame 108. For example, the battery 110 may store from 100 to 200 kilowatt hours (kWh). The battery 110 may be a lithium-ion battery or other type of rechargeable battery. The battery may be substantially planar in shape.

Power from the battery 110 may be supplied to one or more drive units 112. Each drive unit 112 may be formed of an electric motor and possibly a gear train providing a gear reduction. In some embodiments, there is a single drive unit 112 driving either the front wheels or the rear wheels of the vehicle 100. In another embodiment, there are two drive units 112, each driving either the front wheels or the rear wheels of the vehicle 100. In yet another embodiment, there are four drive units 112, each drive unit 112 driving one of four wheels of the vehicle 100.

Power from the battery 110 may be supplied to the drive units 112 by one or more sets of power electronics 114, such as power electronics for each drive unit 112 or pair of drive units 112. The power electronics 114 may include inverters configured to convert direct current (DC) from the battery 110 into alternating current (AC) supplied to the motors of the drive units 112. The power electronics 114 further facilitate operation of the motors of the drive units as generators to provide regenerative braking. The power electronics 114 further facilitate the transfer of regenerative current to the battery 110.

The drive units 112 are coupled to two or more hubs 116 to which wheels 105 may mount. Each hub 116 includes a corresponding brake 118, such as the illustrated disc brakes. Each hub 116 is further coupled to the frame 108 by a suspension 120. The suspension 120 may include metal or pneumatic springs for absorbing impacts. The suspension 120 may be implemented as a pneumatic or hydraulic suspension capable of adjusting a ride height of the chassis 106 relative to a support surface. The suspension 120 may include a damper with the properties of the damper being either fixed or adjustable electronically.

In the embodiment of FIG. 1B, the vehicle 100 is a battery electric vehicle. However, a hybrid-electric vehicle may also benefit from the approach described herein. In particular, the vehicle 100 may be any vehicle having a front trunk or a rear trunk implemented according to the approach described herein.

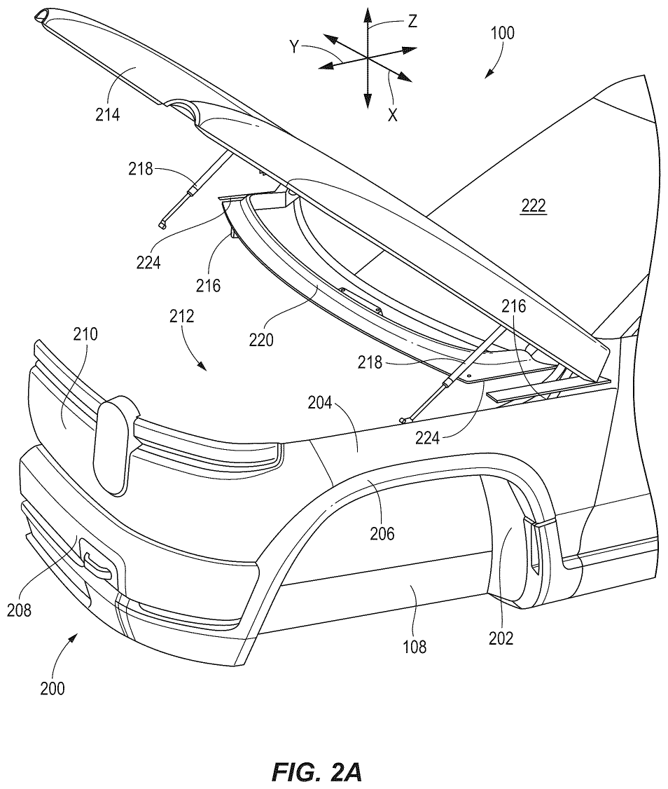

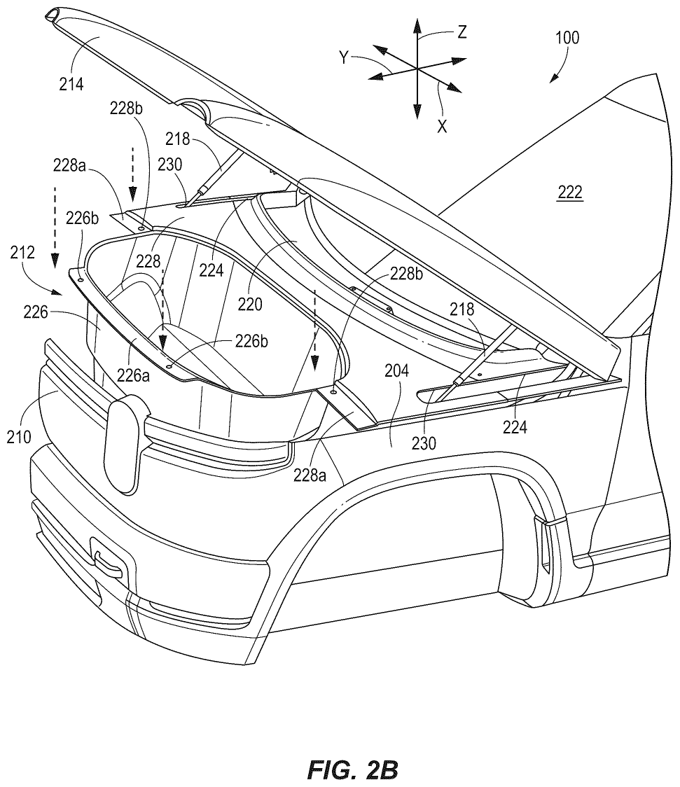

Referring to FIG. 2, the vehicle 100 may include a front body portion 200 mounted to the frame 108 or forming part of the frame 108 of the vehicle 100 (e.g., unibody construction). The front body portion 200 defines the exterior of the vehicle forward of the driver. The front body portion 200 therefore may include one or more pieces of sheet metal, plastic, or other materials forming the exterior of the vehicle 100. The examples disclosed herein are with respect to a front body portion 200 extending over and around the front wheels 105 of the vehicle 100 with the understanding that a trunk or other accessible cavity in a rearward body portion of the vehicle 100 may be implemented in a like manner.

The vehicle 100 may be understood with respect to X, Y, and Z directions. The Z direction may correspond to the direction of gravity when the vehicle 100 is on a flat, level surface perpendicular to the direction of gravity. The Y direction may correspond to the direction of the vehicle 100 when traveling in a straight line. The X direction may be defined as perpendicular to the Y and Z directions.

The front body portion 200 may include wheel wells 202 for containing the road wheels 105 mounted to the hubs 116, front quarter panels 204 extending over the wheel wells 202, fenders 206, or other components extending around the front wheels of the vehicle 100. The front body portion may likewise include a bumper 208 and grill 210 extending between the front quarter panels 204. In an electric vehicle, the grill 210 may simply be a front facing panel or may provide an inlet for cooling air flow. The bumper 208 and/or grill 210 may have components mounted thereon, such as headlights, turn signal lights, a light bar, sensors (ultrasonic, radar, etc.), or other components. The front body portion 200 may extend over a portion of the frame 108 defining a front crumple zone for mitigating harm to passengers during collisions.

The front body portion 200 defines a bay 212. The bay 212 may define a volume used for storage, e.g., a front trunk (“frunk”) for storing cargo. The bay 212 may also define a volume for functional components of the vehicle such as reservoirs for fluids (brake fluid, coolant, windshield wiper fluid, etc.), degas container, electronic components (e.g., one or more electronic control units (ECU), or other components of the vehicle 100. Portions of the suspension 120 may also extend into the bay 212.

The bay 212 may be covered by a hood 214. The hood 214 may be secured by hinges 216 to a structural member mounted to the frame 108. The hinges 216 may enable pivoting of the hood 214 about an axis substantially (e.g., within 5 degrees of) parallel to the X direction. The hood 214 may be supported by gas springs 218 or other supports to maintain the hood 214 in an open position once moved to the open position (e.g., by a user). When in a closed position, the hood 214 may cooperate with the front quarter panels 204 and grill 210 to cover the bay 212.

The bay 212 may include various cosmetic and functional panels that cover functional components mounted within the bay 212. For example, a leaf guard 220 may extend from a windshield 222 to the bay 212 and possibly into the bay 212. The leaf guard 220 may conduct water and debris descending from the windshield 222 away from the bay 212 and otherwise block debris from entering the bay 212 through a gap between the windshield 222 and the hood 214 when closed. The leaf guard 220 may define slots 224 for receiving the gas springs 218 when the hood 214 is closed and possibly providing clearance for struts coupling the hood 214 to the hinges 216.

Referring specifically to FIG. 2B, the bay 212 may contain a tub 226. The tub 226 defines a volume that is available to store cargo and is relatively isolated from the remainder of the bay 212 and the environment of the vehicle 100 when the hood 214 is closed. For example, the tub 226 may define an available volume (e.g., available for storing cargo) when the hood 214 closed that is at least 1, 2, or more times the size of carry-on luggage having a size approved by the Transportation Security Administration (TSA), e.g. 9 inches by 14 inches by 22 inches. Stated differently, the tub 226 may define an available volume of at least 1.6 cubic feet or more, such as at least 3.2 cubic feet. The upper edge of the tub 226 may be oriented parallel to or at a slight incline (e.g., less than 10, less than 5, or less than 2 degrees) relative to the plane defined by the X and Y directions. The upper edge may be planar or contoured to conform to an underside of the hood 214. The upper edge may lie within a 15, 10, or 5 centimeters of a plane that is oriented at a slight incline (e.g., less than 10, less than 5, or less than 2 degrees) relative to the plane defined by the X and Y directions.

The tub 226 is monolithically formed with an access panel 228 using a common mold, such as by gate sequenced injection molding. Gate sequenced injection molding may include activating a first set of gates to inject a first polymer portion into a mold followed by opening a second set of gates to inject a second polymer portion into the same mold. The access panel 228 substantially covers an area over the bay 212 between the tub 226 and the leaf guard 220 and between the tub 226 and the perimeter of the bay 212, such as spanning at least 90 percent of a distance from the tub 226 and the perimeter of the bay 212. For example, the access panel 228 may further extend outwardly from the tub 226 (e.g., in the X direction) substantially to the front quarter panels 204. The access panel 228 may extend rearwardly (e.g., in the Z direction) from the tub 226 to the leaf guard 220 and may overlap the leaf guard 220 in the Z direction or a flange or other component secured to the leaf guard 220.

Access panel 228 may be substantially planar, such as within 5, 3, or 1 centimeter from planar across at least 60, 80, or 90 percent of the extent thereof in the X and Y directions. The access panel 228 may be oriented parallel to or at a slight incline (e.g., less than 10, less than 5, or less than 2 degrees) relative to the plane defined by the X and Y directions. The access panel may define slots 230 that provide clearance for the gas springs 218 and possibly structural components connecting the hood 214 to the hinges 216. The slots 230 may be aligned with the slots 224 in the leaf guard 220.

The access panel 228 may be joined to the tub 226 by side portions 228a. The upper edge of the tub 226 may be otherwise detached from the access panel 228. In particular, the portion of the upper edge of the tub 226 extending between the side portions 228a is detached from the access panel 228. The side portions 228a may secure to a structural member within the bay 212 using fasteners 228b. The tub 226 and any cargo placed therein may be supported by structural members other than the side portions 228a such that the side portions 228a function primarily as a covering to improve aesthetics of the bay 212 and hinder contamination of functional components covered by the side portions 228a.

The tub 226 may further be secured to structures within the bay 212. For example, the tub 226 may include a flange 226a, such as on an opposite side of the tub 226 from the access panel 228 along the Y direction. Openings 226b formed in the flange 226a may receive fasteners securing the flange 226a to a structure within the bay 212.

The leaf guard 220, apron panel 232, and the combined tub 226, access panel 228, and side portions 228a may be formed of plastic, metal, or composite material. For example, these components may be formed from any plastic used for forming interior panels, engine covers, or other trim as known in the automotive industry (e.g., nylon, acrylonitrile butadiene styrene (ABS), polypropylene, polyvinyl chloride (PVC), or the like).

Referring to FIG. 2C, a remaining portion of the bay 212 that is not covered by the tub 226, access panel 228, side portions 228a, and the leaf guard 220 may be covered by an apron panel 232. The apron panel 232 may be substantially planar, such as within 5, 3, or 1 centimeter from planar across at least 60, 80, or 90 percent of the extent thereof in the X and Y directions. The apron panel 232 may be oriented parallel to or at a slight incline (e.g., less than 10, less than 5, or less than 2 degrees) relative to the plane defined by the X and Y directions.

The apron panel 232 and access panel 228 may form a contoured surface. For example, a radius of curvature of the apron panel 232 may be substantially (e.g., within 1 percent of) equal to the radius of curvature of the access panel 228, excluding a region within 1 centimeter of the edges of the apron panel 232 and access panel 228 that are facing one another to account for bevels, chamfers, or other edge treatments of the edges.

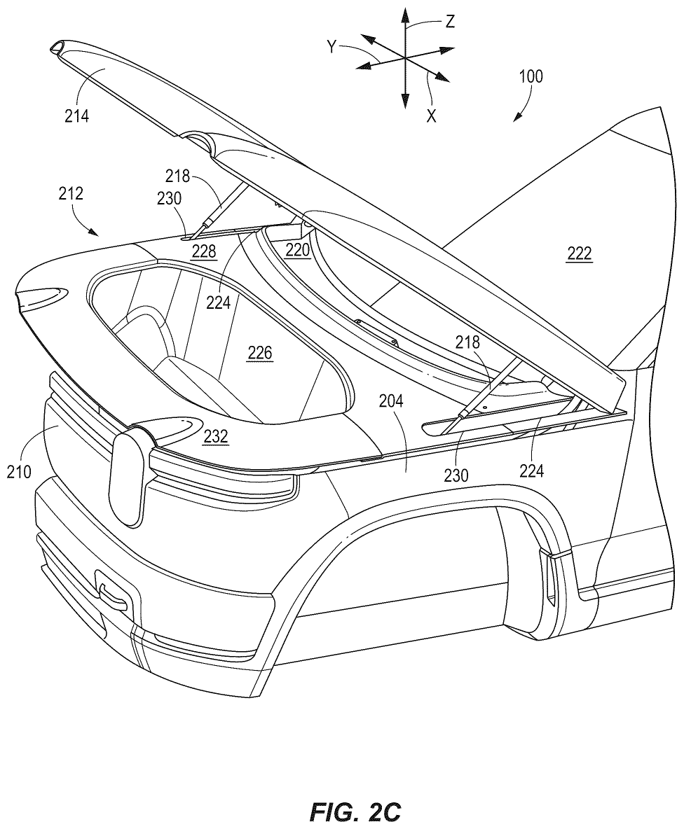

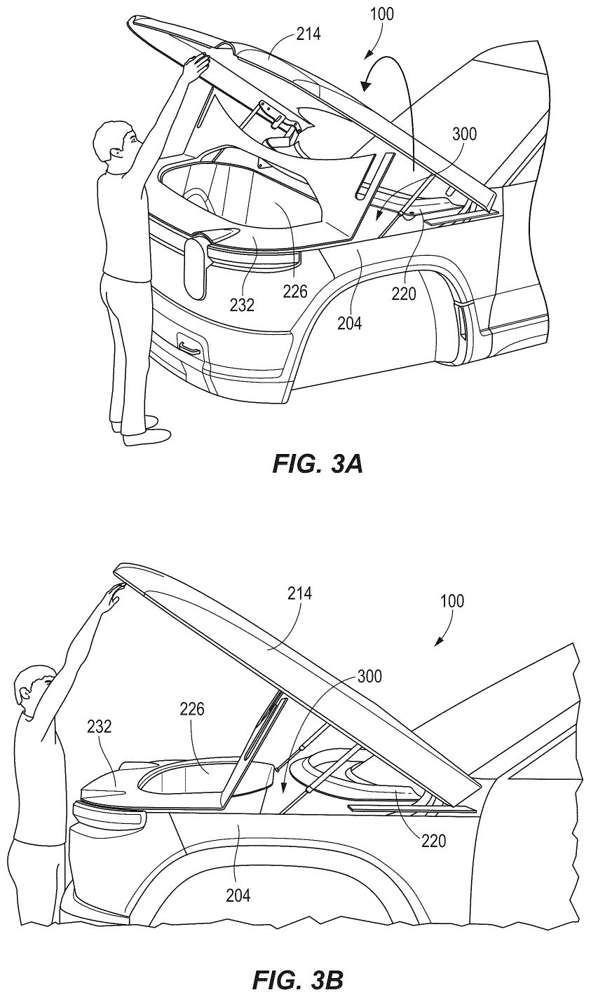

Referring to FIGS. 3A and 3B, material joining the side portions 228a to the access panel 228 may be flexible, e.g., a living hinge, such that the access panel 228 may pivot relative to the side portions 228a without failure. For example, the access panel 228 may pivot about an axis of rotation that is substantially (e.g., within 5 degrees of) parallel to the axis of rotation of the hood 214, such as an axis of rotation substantially parallel to the X direction.

The access panel 228 therefore has a closed position shown in FIGS. 2B and 2C in which the access panel 228 remains while the hood 214 is closed and in normal operation. The access panel 228 further has an open position shown in FIGS. 3A and 3B that is achievable when the hood 214 is open. The access panel 228 may be pivoted to the open position to fill one or more reservoirs and/or to access components positioned around the tub 226 in the bay 212.

As shown in FIGS. 3A and 3B, an access opening 300 may be defined between the tub 226 and the leaf guard 220. The access opening 300 may further extend between left and right front quarter panels 204 of the vehicle 100. The access opening 300 may provide access to some or all of reservoirs for fluids (e.g., brake fluid, coolant, windshield wiper fluid, etc.), degas container, electronic components (e.g., one or more electronic control units (ECU), portions of the suspensions 120, or other components of the vehicle 100.

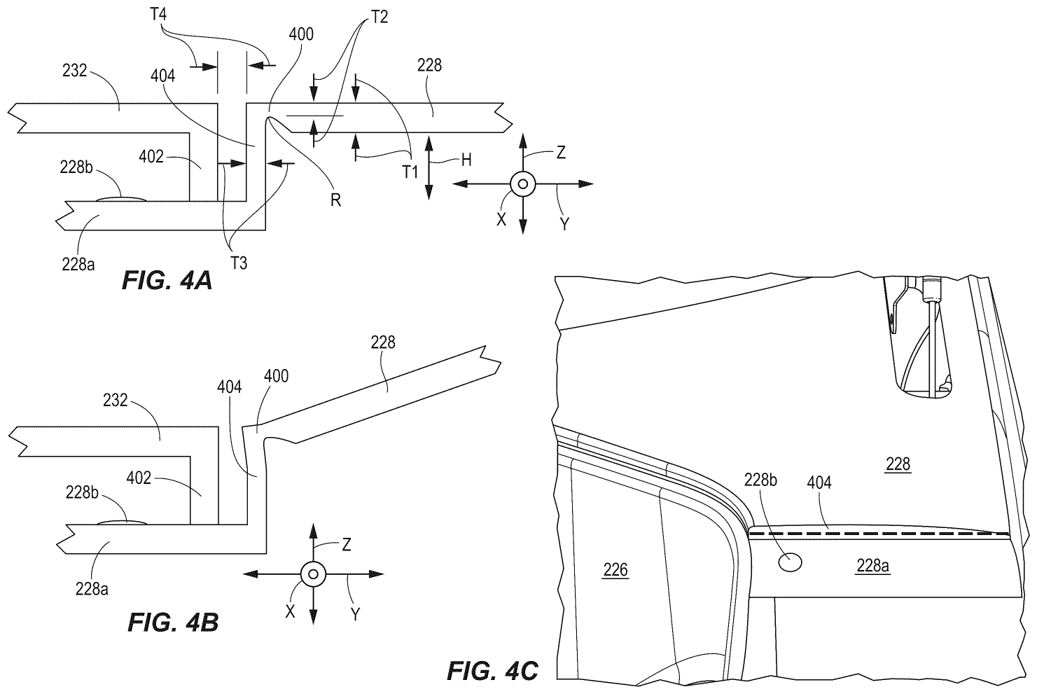

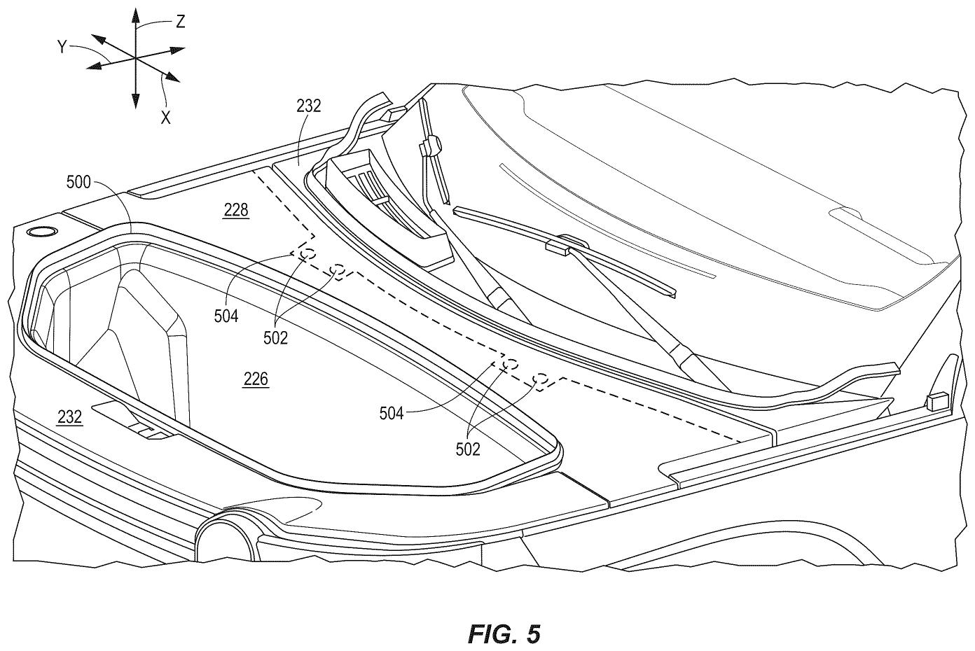

FIGS. 4A, 4B, and 4C illustrate an example approach for implementing a living hinge attaching the access panel 228 to the side portions 228a. The approach shown in FIGS. 4A, 4B, and 4C is exemplary only, and other approaches for implementing a living hinge using compliant materials may also be used.

In some embodiments, a living hinge is implemented by two hinge portions 400, where each hinge portion 400 joins one of the side portions 228a to the access panel 228. For example, the access panel 228, and possibly each side portion 228a may have a thickness T1 whereas the hinge portion 400 has a thickness T2 that is much less than T1, such as less than 0.5, 0.25, or less than 0.15 times the thickness T1. For example, T1 may be between 2 and 4 millimeters, such as between 2.5 and 3.5 mm, such as between 2.9 and 3.1 millimeters. In contrast, T2 may be between 0.3 and 1 millimeters, such as between 0.35 and 0.75 millimeters, such as between 0.45 and 0.65 millimeters, such as between 0.5 and 0.6 millimeters. For example, T2 may be about 0.55 millimeters. In some embodiments T1 and T2 are measured along the Z direction.

As is apparent in FIG. 4A, there may be a sloped or curved transition between the thickness T1 and the thickness T2 of the hinge portion 400. For example, the curved transition may have an extent of between 0.5 and 2 centimeters. An apex of the hinge portion 400 may have a radius of curvature R selected to reduce force concentrations and extend the fatigue life of the hinge portion 400. The apex may be defined as the region having the smallest thickness when the access panel 228 is in the closed position. R may be at least 0.1 millimeters, at least 0.2 millimeters, at least 0.4 millimeters, or at least 0.8 millimeters.

In some embodiments, one or more features may be formed on the side portions 228a to position the access panel 228 relative to the apron panel 232 in order to present a smooth contour for aesthetic or functional reasons. For example, a flange 402 extending downwardly from the apron panel 232 in the Z direction may rest on the side portions 228a. The flange 402 may provide a space below the apron panel 232 to provide clearance for the fasteners 228b covered by the apron panel 232 or for other purposes. A flange 404 may be formed on each side portion 228a. Each flange 404 extends upwardly from each side portion 228a in the Z direction and connects to the hinge portion 400 such that the hinge portion 400 joins the flange 404 to the access panel 228. The flange 404 may maintain the access panel 228 at a height H above the side portion 228a. The flange 402 may be monolithically formed with the apron panel 232, such as by molding in a common mold, such as using gate sequenced injection molding. The flange 404 may be monolithically formed with the access panel 228 and side portions 228a, such as by forming in a common mold, such as using gate sequenced injection molding.

The flange 404 may have a thickness T3, such as in the Y direction. The thickness T3 may be less than the thickness T1. For example, T3 may be between 1 and 3 millimeters, such as between 1.5 and 2.5 millimeters. In some embodiments, the reduced thickness T3 may facilitate bending of the flange 404 during lifting of the access panel 228 (see FIG. 4B). For example, at least 5, 10, 20, or 30 percent of an angle traversed by the access panel 228 (e.g., 35 degrees) from the closed position of FIG. 4A may be a result of bending of the flange 404 with a remainder being a result of deformation of the hinge portion 400, e.g., a region within 3 millimeters of the apex of the hinge portion 400.

However, in other embodiments, the thickness T3 is selected such that no substantial bending of the flange 404 occurs during rotation of the access panel, e.g., less than 5 percent or less than 2 percent of the angle traversed by the access panel 228 (e.g., 35 degrees) from the closed position of FIG. 4A may be a result of bending of the flange 404 with a remainder being a result of deformation of the hinge portion 400.

In either case, the access panel 228 has an effective axis of rotation defined by the hinge portions 400 that is substantially (e.g., within 5 degrees of) parallel to the X direction. The location of the axis of rotation in the Y-Z plane may be defined by a point in the hinge portions 400 or offset therefrom where substantial bending of the flange 404 occurs.

In various embodiments, the access panel 228 is not regularly pivoted during use. Accordingly, the hinge portion 400 (and the flange 404 if substantial bending occurs) may have a fatigue life selected to avoid failure during the expected service life of the vehicle 100. For example, the fatigue life may be between 200 and 300 cycles (opening and closing) assuming about 10 uses per year and a service life of at least 20 years. To reduce likelihood of premature failure, the fatigue life may be greater, such as between 300 and 1000 cycles.

As is apparent in FIGS. 4A and 4B, the flanges 402, 404 may be offset from one another in the Y direction, such as by a distance T4. The offset may be selected for aesthetic reasons (perception of quality due to panel gaps) or functional reasons. For example, T4 may be selected such that, for an expected range of movement of the access panel 228 in the Y direction when moving from the closed position to the open position (e.g., an angle between 30 and 60 degrees), deflection of the flange 404 in the Y direction will not result in contact with the apron panel 232 by the flange 404, access panel 228, hinge portion 400, or any other portion molded with the access panel 228, the hinge portion 400, and the flange 404.

Referring to FIGS. 5, 6, and 7, a dust seal 500 may extend around an upper perimeter of the tub 226. When the hood 214 is closed, the dust seal 500 may engage an inner surface of the hood 214, a corresponding seal secured to the inner surface of the hood 214, or other structure secured to the hood 214. The engagement of the dust seal 500 with the hood 214 (directly or by way of another structure secured thereto) resists entry of contaminants into the tub 226. The dust seal 500 may be made of a natural or synthetic rubber, silicone, or another compliant polymer. The dust seal 500 may be made of a compliant material, such as with a hardness of between 20 and 70 Shore A.

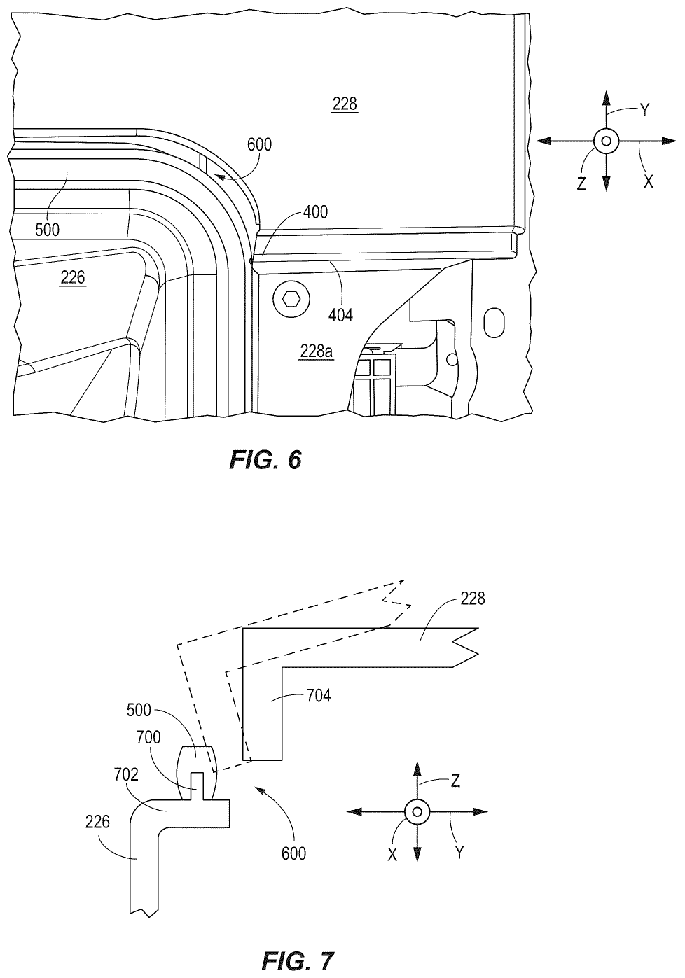

As seen in FIG. 6, a gap 600 may be present at an interface between the tub 226 and the access panel 228 to facilitate movement of the access panel 228 relative to the tub 226. The gap 600 may extend between the side portions 228a and may extend between the tub 226 and the hinge portion 400 and the flange 404. The gap 600 therefore extends along the extent of the tub 226 in the X direction and partially along the extent of the tub 226 in the Y direction. Accordingly, the hinge portion 400 and flange 404 may be secured to the tub 226 only by way of the side portions 228a, thereby facilitating movement of the hinge portion 400 and possibly bending of the flange 404.

The gap 600 may be formed after molding of the tub 226, access panel 228, and side portions 228a or may be formed in a subsequent manufacturing step. In some embodiments, the gap 600 is formed by a core out implemented by dies used to mold the tub 226, access panel 228, and side portions 228a.

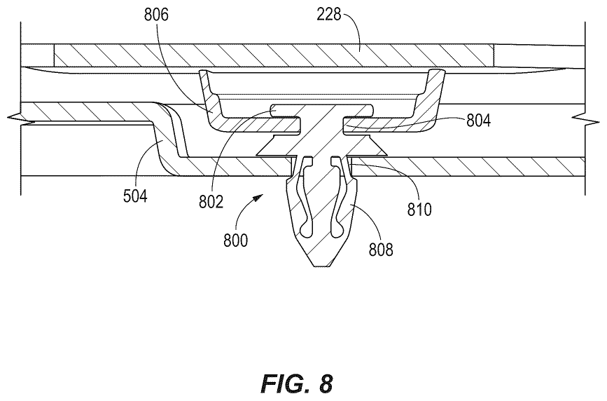

Referring specifically to FIG. 7, the gap 600 may be selected to facilitate free movement of the access panel 228 relative to the tub 226. For example, the dust seal 500 may be secured to a rib 700 extending around the tub 226, such as a rib 700 completely around the tub 226. In the illustrated embodiment, the rib 700 is formed on an outwardly extending flange 702 defining a perimeter of the tub 226. The access panel 228 may have a corresponding flange 704 extending along the gap 600.

When pivoting from the closed position to the open position, the flange 704, or other portion of the access panel 228, may be moved closer to the tub 226 in the Y direction. In some implementations, contact between the flange 704, or other portion of the access panel 228, and the dust seal 500 may occur. Compliance of the dust seal 500 may limit or prevent damage from such contact. In other embodiments, the gap 600 is sized such that such contact does not occur.

Referring again to FIG. 5, when in the closed position, the access panel 228 may latch relative to the remainder of the vehicle 100, such as by latching to the leaf guard 220 or other structure within the bay 212. In the illustrated embodiments, releasable fasteners 502 are non-releasably secured to the access panel 228 and releasably secured to the leaf guard 220. Alternatively, the fasteners 502 may releasably secured to the access panel and be non-releasably secured to the leaf guard 220. As used herein, “releasable” may be understood as requiring less than 15, 10, or 5 pounds of force to release and “non-releasable” may be understood as requiring more than 15, 20, or 25 pounds of force to release. The fasteners 502 may releasably latch without the use of tools. In the illustrated embodiment, the fasteners releasably engage extensions 504 formed on the leaf guard 220 that extend under the access panel 228. Alternatively, the fasteners 502 may be non-releasably secured to the extensions 504 and releasably engage openings defined by the access panel 228.

Referring to FIG. 8, the fasteners 502 may be implemented as any manually releasable fastener known in the art, particularly those used for securing decorative trim or internal panels to a vehicle as known in the automotive industry. For example, the fasteners 502 may be implemented as the illustrated retainer clip 800. The retainer clip 800 may include a head 802 that non-releasably secures the retainer clip 800 to the access panel 228, such as within an opening 804 defined by the access panel 228. In the illustrated embodiment, the opening 804 is defined in a bracket 806 secured to the access panel 228, referred to as a “dog house” in the automotive industry. The leaf guard 220, such as an extension 504 secured to the leaf guard 220, may receive a clip portion 808 of the retention clip 800. For example, the extension 504 may define an opening 810 into which the clip portion 808 inserts. The clip portion 808 may deflect upon insertion through the opening 810 with a portion thereof biased outwardly following insertion, thereby resisting removal. The clip portion 808 may then be disengaged by pulling upwardly on the access panel 228 with sufficient force to deflect the clip portion 808 and force the clip portion 808 out of the opening 810. Pulling upwardly on the access panel 228 may be performed manually or using a trim tool.

The descriptions of the various embodiments of the present disclosure have been presented for purposes of illustration. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure may exceed the specific described embodiments. Instead, any combination of the features and elements, whether related to different embodiments, is contemplated to implement and practice contemplated embodiments. Furthermore, although embodiments disclosed herein may achieve advantages over other possible solutions or over the prior art, the embodiments may achieve some advantages or no particular advantage. Thus, the aspects, features, embodiments and advantages discussed herein are merely illustrative.

While the foregoing is directed to embodiments of the present disclosure, other and further embodiments may be devised without departing from the basic scope thereof, and the scope thereof is determined by the claims that follow.

What is claimed is:

1. A vehicle component comprising:
a tub configured to store cargo;
an access panel configured to cover at least a portion of a bay defined by a vehicle; and
a living hinge coupling the tub to the access panel, wherein the tub, the access panel, and the living hinge are monolithically formed in a common mold.

2. The vehicle component of claim 1, wherein the tub defines a storage volume of at least 1.6 cubic feet.

3. The vehicle component of claim 1, further comprising a dust seal extending around a perimeter of the tub.

4. The vehicle component of claim 1, further comprising:
a first side portion extending outwardly from the tub; and
a second side portion extending outwardly from the tub, the tub being positioned between the first side portion and the second side portion, the first side portion and the second side portion being monolithically formed with the tub in the common mold, the living hinge comprising a first hinge portion connecting the first side portion to the access panel and a second hinge portion connecting the second side portion to the access panel.

5. The vehicle component of claim 4, wherein the tub is detached from the access panel between the first side portion and the second side portion.

6. The vehicle component of claim 4, wherein the access panel has a first thickness, the first hinge portion and the second hinge portion have a second thickness at thinnest points thereof, the second thickness being less than 0.25 times the first thickness.

7. The vehicle component of claim 6, further comprising:
a first flange extending between the first hinge portion and the first side portion; and
a second flange extending between the second hinge portion and the second side portion;
wherein the first flange and the second flange have a third thickness that is less than the first thickness and greater than the second thickness.

8. A vehicle comprising:
a chassis having one or more drive units and a plurality of wheels mounted thereto;
one or more panels defining an exterior of the vehicle mounted to the chassis, the one or more panels defining a bay;
a cover having a closed position covering the bay;
one or more functional components mounted within the bay; and
a molded component positioned in the bay, the molded component comprising:
a tub configured to store cargo;
an access panel; and
a living hinge coupling the tub to the access panel, the access panel being rotatable from a closed position in which the access panel covers the one or more functional components and an open position in which the one or more functional components are accessible.

9. The vehicle of claim 8, wherein the one or more functional components include one or more fluid reservoirs.

10. The vehicle of claim 8, wherein the vehicle comprises a windshield, the access panel being positioned between the windshield and the tub.

11. The vehicle of claim 10, wherein the vehicle comprises a leaf guard positioned at a lower edge of the windshield, the access panel being removably latched to the leaf guard.

12. The vehicle of claim 8, wherein the one or more panels form a grill and left and right front quarter panels of the vehicle.

13. The vehicle of claim 8, further comprising a dust seal extending around a perimeter of the tub, the dust seal positioned to engage the cover when the cover is in the closed position.

14. The vehicle of claim 8, wherein the tub defines a storage volume of at least 1.6 cubic feet.

15. The vehicle of claim 8, wherein the molded component comprises:
a first side portion extending outwardly from the tub to a perimeter of the bay; and
a second side portion extending outwardly from the tub to the perimeter of the bay, the tub being positioned between the first side portion and the second side portion, the living hinge comprising a first hinge portion connecting the access panel to the first side portion and a second hinge portion connecting the second side portion to the access panel;
wherein the tub is detached from the access panel between the first side portion and the second side portion.

16. The vehicle of claim 15, wherein the access panel has a first thickness, the first hinge portion and the second hinge portion have a second thickness at thinnest points thereof, the second thickness being less than 0.25 times the first thickness.

17. The vehicle of claim 16, further comprising:
a first flange extending between the first hinge portion and the first side portion; and
a second flange extending between the second hinge portion and the second side portion;
wherein the first flange and the second flange have a third thickness that is less than the first thickness and greater than the second thickness.

18. A method for accessing a vehicle comprising:
opening a cover from a cover closed position to a cover open position, the cover covering a bay defined by one or more body panels of a vehicle when in the cover closed position; and
opening an access panel from a panel closed position to a panel open position, the access panel being part of a molded component including a tub configured to store cargo, the molded component including a living hinge coupling the tub to the access panel, opening the access panel including bending the living hinge;
wherein one or more functional components of the vehicle positioned in the bay are exposed when the access panel is open.

19. The method of claim 18, wherein opening the access panel comprises unlatching the access panel from a structure within the bay.

20. The method of claim 18, wherein the molded component comprises:
a first side portion extending outwardly from the tub to a perimeter of the bay; and
a second side portion extending outwardly from the tub to the perimeter of the bay, the tub being positioned between the first side portion and the second side portion, the living hinge comprising a first hinge portion connecting the access panel to the first side portion and a second hinge portion connecting the second side portion to the access panel;
wherein the tub is detached from the access panel between the first side portion and the second side portion.
